(19) United States
(12) Patent Application Publication
(10) Pub. No.: US 2020/0362233 A1
(43) Pub. Date: Nov. 19, 2020

(54) COMPOSITIONS OF, AND METHODS FOR MAKING, LIGHTWEIGHT PROPPANT PARTICLES

(71) Applicant: CARBO CERAMICS INC., Houston, TX (US)

(72) Inventors: Thu LIENG, Richmond, TX (US); Todd ROPER, Katy, TX (US)

(21) Appl. No.: 16/411,417

(22) Filed: May 14, 2019

(51) Int. Cl. C09K 8/80

(52) U.S. Cl. CPC C09K 8/805

(57) ABSTRACT

A coated proppant particle includes a porous ceramic substrate, a hydrophobic treatment material, a resin, an adhesion promoter, a resin crosslinker, and a surface treatment material.

### FIELD

The present disclosure provides composition of, and method for making, proppant particles.

### BACKGROUND

In order to stimulate and more effectively produce hydrocarbons from oil and gas bearing formations, and especially formations with low porosity and/or low permeability, induced fracturing (called “frac operations,” “hydraulic fracturing,” or simply “fracing”) of the hydrocarbon-bearing formations has been a commonly used technique. In a typical hydraulic fracturing operation, fluid slurries are pumped downhole under high pressure, causing the formations to fracture around the borehole, creating high permeability conduits that promote the flow of the hydrocarbons into the borehole. These frac operations can be conducted in horizontal and deviated, as well as vertical, boreholes, and in either intervals of uncased wells, or in cased wells through perforations.

In cased boreholes in vertical wells, for example, the high pressure fracturing fluids exit the borehole via perforations through the casing and surrounding cement, and cause the formations to fracture, usually in thin, generally vertical sheet-like fractures in the deeper formations in which oil and gas are commonly found. These induced fractures generally extend laterally a considerable distance out from the wellbore into the surrounding formations, and extend vertically until the fractures reach a formation that is not easily fractured above and/or below the desired frac interval. The directions of maximum and minimum horizontal stress within the formation determine the azimuthal orientation of the induced fractures.

The high pressure fracturing fluids contain particulate materials called proppants. The proppants are generally composed of sand, resin-coated sand or ceramic particulates, and the fluid used to pump these proppant particulates downhole. The fluid is usually designed to be sufficiently viscous such that the proppant particulates remain entrained in the fluid as it moves downhole and out into the induced fractures. After the proppant has been placed in the fracture and the fluid pressure relaxed, the fracture is prevented from completely closing by the presence of the proppants which thus provide a high conductivity flow path to the wellbore which results in improved production performance from the stimulated well.

Sometimes, a wellbore will need to be “gravel packed” before production from the well begins in order to prevent particles (typically referred to as formation fines) from entering the wellbore. Gravel packing is done in formations that contain individual sand grains that are not tightly cemented together. If the individual sand grains remain unconsolidated, when production of the formation begins, the force of fluid flow will tend to move the unconsolidated sand grains into the wellbore. Gravel packing prevents this problem. In gravel packing, proppants, also referred to as gravel pack particles, are placed in the annulus of a wellbore, next to the unconsolidated formation fines, essentially working as a filter between the wellbore and the formation. The proppants are held in place by a slotted screen which prevents the proppants (and formation fines) from migrating into the wellbore, while still allowing the formation fluids to do so. If the wellbore is cased, the casing is first perforated in order to establish communication between the wellbore and the formation. The gravel packing process is generally performed in all formations that are considered to have unconsolidated formation fines, like those commonly found in the Gulf of Mexico.

Water injection wells may also be gravel packed because when a water injection well is shut-in, there can be a pressure surge or flowback into the wellbore which might result in an immediate flow of formation fines into the well. If formation fines are allowed to flow into the well, the formation could become plugged, which would prevent the resumption of injection of water into the well.

Similarly, wellbores can also be “frac packed.” Frac packing involves the simultaneous hydraulic fracturing of a reservoir and the placement of a gravel pack in the annular region of the wellbore. In frac packing, a fracture is created using a high-viscosity fluid that is pumped into the formation above the fracturing pressure. Gravel pack screens are in place at the time of pumping and function the same way as in a typical gravel packing operation. Creating the fracture helps improve production rates while the gravel pack prevents formation fines from being produced and the gravel pack screens prevent the proppants from being produced with the produced fluids. This method allows for high conductivity channels to penetrate deeply into the formation while leaving the area around the wellbore undamaged. More than 65% of the completions in the Gulf of Mexico use frac pack systems.

In each case, to maximize an increase in permeability and prevent proppant flowback, the proppant particulates can be consolidated inside the propped fracture or a gravel packed or frac packed region, forming a “proppant pack.” Typically, resin-coating the proppant particulates allows for consolidation of the particulates at downhole conditions of temperatures of about 150° F. or higher and a closure stress of about 1000 psi. However, some hydraulic fracturing, gravel packing, and frac packing procedures are conducted at much lower temperatures and in the case of gravel packing, with no closure stress.

In addition to the ability to form a consolidated proppant pack under downhole conditions and in a gravel packed or frac packed region, it is desirable that the curable resin-coated proppant is an ultra-lightweight proppant that reduces the rate of proppant settling, thereby allowing lower pumping rates through the use of low viscosity fluids. Conventional proppant involves entrainment in a viscous fluid system, which requires use of higher pumping rates. These higher pumping rates can create voids in a gravel pack. Therefore, a need exists for an ultra-lightweight resin-coated proppant that remains unconsolidated during storage and in the wellbore, but is capable of forming a consolidated proppant pack downhole and in a gravel packing process at low temperatures and confining stresses.

### BRIEF SUMMARY

A coated proppant particle is disclosed. The particle includes a porous ceramic substrate, a hydrophobic treatment material, a resin, an adhesion promoter, a resin crosslinker, and a surface treatment material.

A proppant slurry is also disclosed. The proppant slurry includes a plurality of coated proppant particles, a frac fluid, and a chemical activator. The coated proppant particles include a porous ceramic substrate, a hydrophobic treatment material, a resin, an adhesion promoter, a resin crosslinker, and a surface treatment material.

A method is also disclosed. The method includes heating a porous ceramic substrate. The method also includes adding a hydrophobic treatment material to the substrate. The method also includes adding a resin to the substrate. The method also includes adding an adhesion promoter to the substrate. The method also includes adding a resin crosslinker to the substrate. The method also includes adding a surface treatment material to the substrate. The hydrophobic treatment material, the resin, the adhesion promoter, the resin crosslinker, the surface treatment material, or a combination thereof form a coating on the substrate, and the substrate and the coating produce a plurality of coated proppant particles.

### BRIEF DESCRIPTION OF THE DRAWINGS

The present invention may best be understood by referring to the following description and accompanying drawings that are used to illustrate embodiments of the invention. In the drawings:

FIG. 1 illustrates a flowchart of a method for producing a plurality of coated particles, according to an embodiment.

FIG. 2 illustrates an image of a cross-section of a substrate for the coated particles, according to an embodiment.

FIG. 3 illustrates a schematic view of a hydrophilic surface of the substrate, according to an embodiment.

FIG. 4 illustrates a schematic view of a hydrophobic surface of the substrate, according to an embodiment.

FIG. 5 illustrates a schematic view of a super-hydrophobic surface of the substrate, according to an embodiment.

FIG. 6 illustrates a flowchart of a method for producing a slurry for use during or after a hydraulic fracturing operation, according to an embodiment.

FIG. 7 illustrates an image of a plurality of coated proppant particles with a fluid bonding the particles together, according to an embodiment.

FIG. 8 illustrates an image of a slug created with 0 pounds per square inch (PSI) closure stress, according to an embodiment.

FIG. 9 illustrates an image of a slug created with 1000 PSI closure stress, according to an embodiment.

FIG. 10 illustrates an image of the slurry in a fracture, according to an embodiment.

### DETAILED DESCRIPTION

Compositions of, and methods for making, lightweight proppant particles are provided. Lightweight proppant particles, such as lightweight ceramic proppant (e.g., having about 2.75 apparent specific gravity “ASG”) has been used in the oilfield industry due to its ease of placement during hydraulic fracturing operations. It provides higher flow capacity, higher crush resistance, and higher fracture conductivity than sand. The proppant may have 0-10% porosity. Ultra-lightweight ceramic proppants (e.g., having an ASG <2.7), have an internal interconnected porosity that ranges from 10% to 45%. Certain porous lightweight proppant, such as CARBOAIR° manufactured by CARBO Ceramics Inc. of Houston, Tex., is treated with a hydrophobic chemical to repel water from the interconnected internal porosity of the proppant, thereby maintaining an ultra-low density in water-based frac fluids (e.g., having 2.0 ASG) while maintaining a crush strength and fluid permeability greater than sand. The ˜30% reduction in pellet density decreases the proppant settling rate and therefore increases proppant transport. The CARBOAIR proppant is also at least partially coated with a cured resin that is designed to provide a hydrophilic or amphiphilic outer layer to allow efficient pumping of the slurry while, at the same time, provide adequate permeability to air and water so that its hydrophobic interconnected internal porosity can function to sufficiently repel water and retain air necessary to achieve the desired reduction in density.

The CARBOAIR proppant has been successfully pumped in horizontal wells as a tail-in, as well as offshore gravel packs and frac packs. These are applications that traditionally utilize curable resin-coated proppant to control fines migration and proppant flowback. The current CARBOAIR coating is pre-cured; however, it has been discovered that the coating may be made reactive (e.g., curable), by applying the CARBOBOND® or FUSION® coatings, which are also manufactured by CARBO Ceramics Inc. of Houston, Texas. Application of a curable coating with a 10-60% curability on CARBOAIR would allow the proppant particles to bond with each other to form a consolidated pack under temperature and pressure in the fracture to prevent proppant flowback. In wells with moderately low reservoir temperature (e.g., 140-180° F.), a low-temperature chemical activator (LTCA) can be used to facilitate proppant pack consolidation. In wells with extremely low reservoir temperatures (less than 140° F.) and/or with little to no closure stress (e.g., 0 PSI), a reactive activator (e.g., FUSION Activator) may be used to consolidate the porous proppant particles. In the case of little to no closure stress (e.g., 0 psi), FUSION Activator may be also used to improve the strength of the consolidated pack of porous proppant particles at temperatures covering the range 140-300° F.

One or more tracers can be added to the ceramic proppant matrix and/or to the coating. The tracers can include non-radioactive tracers, such as CARBONRT (or “NRT”), commercially available from CARBO Ceramics Inc. of Houston, Texas, or soluble chemical tracers, such as DNA. NRT can directly measure the near-wellbore proppant placement in the fracture and/or the pack quality in the wellbore annulus (e.g., a screened gravel pack). In water injection wells (e.g., gravel pack “GP” and/or frac pack “FP”), a soluble tracer in the coating can be detected as it is being produced in nearby producing wells, indicating water breakthrough. In conventional hydraulic fracturing operations, the soluble tracers can be detected in oil/water as oil/water are being produced from each stage.

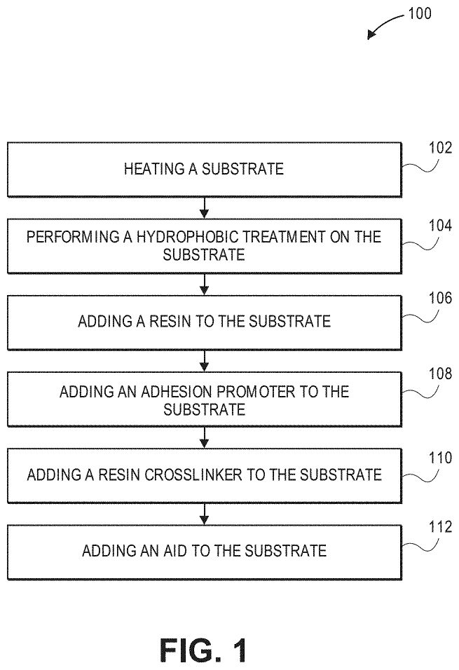

The coated particles may be produced in accordance with any of the methods of manufacture disclosed in U.S. Pre-Grant Publication No. 2017/0145301A1, the entire disclosure of which is incorporated by reference herein. FIG. 1 illustrates a flowchart of a method 100 for producing a plurality of coated particles, according to an embodiment. The coated particles may be or include reactive ultra-lightweight coated proppant particles. In one example, the coated proppant particles may be or include CARBOAIR proppant particles.

The method 100 may include heating a substrate, as at 102. The substrate may be or include a porous ceramic material. For example, the substrate may be or include KRYPTOSPHERE® LD (KSLD) and/or diatomaceous earth-doped kaolin pellets. In at least one embodiment, the substrate may be or include glass beads, hollow glass beads and/or plastic beads. In a particular example, the substrate may be or include CARBOULTRALITE® material manufactured by CARBO Ceramics Inc. of Houston, Tex.

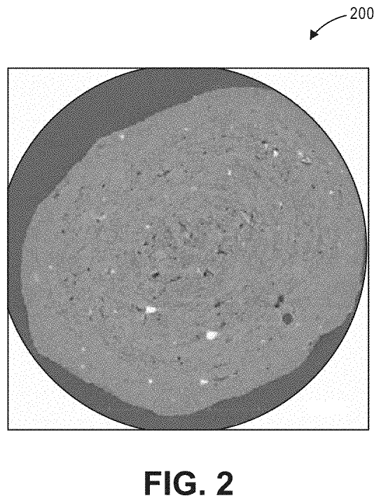

FIG. 2 illustrates an image of a cross-section of a substrate 200, according to an embodiment. The substrate 200 shown is made of a ceramic material and has a porosity of about 20%. In other examples, the substrate 200 may have a porosity from about 1% to about 50%, from about 5% to about 40%, or from about 20% to about 35%. The substrate 200 may have a bulk density, measured in accordance with ASTM D1895 method B, from about 0.6 g/cm³ to about 1.75 g/cm³, from about 0.8 g/cm³ to about 1.55 g/cm³, or about 1 g/cm³ to about 1.25 g/cm³. The substrate 200 may have a U.S. Standard Mesh Sieve Size, or sieve size, from about 40/70 mesh to about 5/8 mesh or from about 40/70 to about 12/18. The substrate may have an interconnected internal porosity, measured in accordance with ISO standard 5017, from about 1% to about 75%, about 5% to about 60%, or about 10% to about 50%. In at least one embodiment, a non-radioactive tracer (NRT) may be added to the substrate and/or the coating.

In another embodiment, the substrate may be composed of bauxite, alumina, or blends thereof. For example, the substrate may include high-strength proppant (HSP) or KRYPTOSPHERE HD (KSHD). For KSHD, the bulk density may be from about 1.75 g/cm³ to about 3.5 g/cm³ or about 2.0 g/cm³ to about 3 g/cm³, and the porosity may be from about 20% to about 35%.

The substrate may be heated to a temperature from about 70° F. to about 500° F., about 200° F. to about 475° F., or about 300° F. to about 450° F. For example, for a phenolic novolac coating, the substrate may be heated to about 450° F. The heater may be or include a bulk solid heater with a direct and/or indirect flame carousel. In other embodiments, a Solex heater and/or a fluid bed may also or instead be used to heat the substrate.

The method 100 may also include performing a hydrophobic treatment on the substrate, as at 104. Performing the hydrophobic treatment may include applying a hydrophobic treatment material to the substrate. The hydrophobic treatment material can be or include any suitable material having hydrophobic properties. The hydrophobic treatment material can be or include any silicon-containing compound, including silicone materials, silanes, and siloxanes, fluorinated organic compounds, polytetrafluoroethylene (commonly known as Teflon™), plant oils, such as linseed oil, soybean oil, corn oil, cottonseed oil, vegetable oil (widely commercially available such as Crisco®), and canola oil, hydrocarbons, such as kerosene, diesel, and crude oil, petroleum distillates, such as hydrocarbon liquids comprising a mixture of C₇-C₁₂ aliphatic and alicyclic hydrocarbons and aromatic hydrocarbons (C₇-C₁₂), commonly known as Stoddard Solvent, aliphatic solvents, solvent naphtha (medium aliphatic and light aromatic), and paraffin, such as solvent dewaxed heavy paraffinic petroleum distillate and stearates, such as calcium stearate. The hydrophobic treatment material can also be or include any one or more polymers or copolymers of acrylates, meth(acrylates), urethanes, epoxies, amides, imides, esters, one or more ethers, olefins, fluorocarbons, and styrenic monomers. The one or more polymers or copolymers can be or include any suitable fluorinated polymers or copolymers. In one or more exemplary embodiments, the hydrophobic treatment material can be or include one or more poly dialkyl siloxanes, such as polydimethylsiloxane (PDMS), one or more organosilanes, such as tetraalkoxysilane and trialkoxysilane, one or more fluorinated siloxanes, one or more fluorinated urethanes, and one or more fluorinated silanes. In one or more exemplary embodiments, the hydrophobic material is PDMS. The PDMS can include modified PDMS, such as minopropyl terminated PDMS, hydroxyl terminated PDMS, acrylate terminated PDMS, methacylate terminated PDMS, silanol terminated PDMS, silane terminated PDMS, and vinyl terminated PDMS.

The hydrophobic treatment material may be used to treat or coat the outer surface and/or interior channel walls of the substrate (e.g., due to the porosity of the substrate), thereby making the surface of the substrate, and its interior porosity, hydrophobic or super-hydrophobic. This may induce water-repellency, which holds air in the substrate and maintains a low density. Thus, the hydrophobic treatment may help to produce a substrate and/or coated proppant particle that is very lightweight in comparison to conventional substrates and/or proppant particles.

For example, after the hydrophobic treatment, the substrate may have an ASG from about 1.0 to about 2.65 (e.g., for a CARBOULTRALITE substrate). In another embodiment, the ASG may be from about 1.9 to about 2.1. A substrate made of porous KSHD may have an ASG from about 2.5 to about 3.2. A substrate made from hollow glass spheres may have an ASG from about 0.06 to about 0.55. The ASG of the substrate may be about 25% less than the fully-fired version.

Subsequent coating (described below) may convert the exterior surface of the substrate back to a hydrophilic surface (i.e., wettable by water). The hydrophobic treatment may be applied in a batch process (e.g., in a mixer) or a continuous process (e.g., using a fluid bed and/or a rotary drum). The hydrophobic treatment may be applied at an ambient temperature or at higher temperatures. For example, the hydrophobic treatment may be applied at a temperature from about 70° F. to about 450° F. The hydrophobic treatment may have a loading from about 0.025 wt % to about 0.25 wt %.

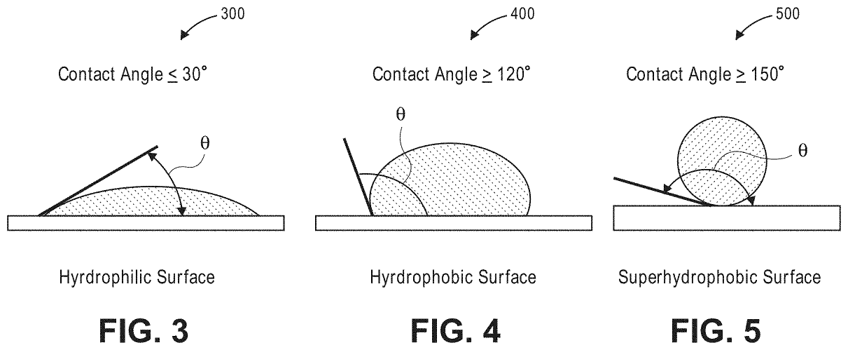

FIG. 3 illustrates a schematic view of a hydrophilic surface 300, according to an embodiment. In one or more embodiments, the hydrophilic surface 300 may have a contact angle Θ that is less than or equal to about 90°, less than or equal to about 60°, or less than or equal to about 30°. FIG. 4 illustrates a schematic view of a hydrophobic surface 400, according to an embodiment. The hydrophobic surface 400 may have a contact angle Θ that is from about 100° to about 150°. FIG. 5 illustrates a schematic view of a super-hydrophobic surface 500, according to an embodiment. The super-hydrophobic surface 500 may have a contact angle Θ that is greater than or equal to about 150°.

The method 100 may also include adding a resin to the substrate, as at 106. The resin may be added before the substrate is heated, simultaneously with the substrate being heated, or after the substrate is heated (and subsequently cooled). The resin may be added before the hydrophobic treatment is performed, simultaneously with the hydrophobic treatment being performed, or after the hydrophobic treatment is performed. For example, the resin may be added to the heated substrate, which may cause the resin to melt and coat the substrate. The resin may be or include a novolac resin, epoxy resin, urethane resin, and/or an acrylic resin. The resin may have a molecular weight from about 400 to about 5000 (GPC analysis). The resin may have a melt viscosity at 150° C. from about 1000 to about 35000 cPs (cone and plate). The resin may be in solid form (e.g., flake or pastille) or in liquid form. In at least one embodiment, a wax may be incorporated in the resin.

The method 100 may also include adding an adhesion promoter to the substrate, as at 108. The adhesion promoter may be added before the substrate is heated, simultaneously with the substrate being heated, or after the substrate has heated (and subsequently cooled). The adhesion promoter may be added before the hydrophobic treatment is performed, simultaneously with the hydrophobic treatment being performed, or after the hydrophobic treatment is performed. The adhesion promoter may be added before the resin is added, simultaneously with the resin being added, or after the resin is added. The adhesion promoter may be or include silane. More particularly, the adhesion promoter may be or include an amine functional silane such as 3-Aminopropyltriethoxysilane (e.g., Momentive A-1100). The adhesion promoter may migrate to the surface of the substrate to form a bond between the substrate and the resin. More particularly, the adhesion promoter may form a covalent bond between the substrate and the resin, which may prevent the resin from peeling off of the substrate.

The method 100 may also include adding a resin crosslinker to the substrate, as at 110. The resin crosslinker may be added before the substrate is heated, simultaneously with the substrate being heated, or after the substrate has heated (and subsequently cooled). The resin crosslinker may be added before the hydrophobic treatment is performed, simultaneously with the hydrophobic treatment being performed, or after the hydrophobic treatment is performed. The resin crosslinker may be added to the substrate before the resin and/or adhesion promoter are added, simultaneously with the resin and/or adhesion promoter being added, or after the resin and/or adhesion promoter are added. The resin crosslinker may be or include hexamethylenetetramine (hexamine), multifunctional isocyanates, or multifunctional amines. The resin crosslinker may be in solid or liquid form. For example, the resin crosslinker may be added as part of a solution containing water that is from about 30% to about 50% (e.g., 40%) resin crosslinker. A ratio of the hexamine to resin may be from about 5:100 to about 25:100 (e.g., about 13:100). The water in the solution may be evaporated, leaving behind the hexamine to react with the resin. The extent of the reaction may be at least partially dependent on the temperature. The reaction may be suspended with the addition of a water quench to impart residual activity in the coating, which may be later coupled with the FUSION activator for low-temperature consolidation. The residual curability may be from about 10% to about 70%, about 15% to about 40%, or about 30% to about 35%. The curing of the resin with the resin crosslinker may result in a high cross-linked density polymer network.

The method 100 may also include adding an aid (also referred to as a surface modifier or a surface treatment material) to the substrate, as at 112. The aid may be or include a parting aid and/or a wetting aid, such as Lubrizol Chembetaine CAS. The aid may be added after the resin crosslinker and/or the quench water. For example, the aid may be added right after the peak of the dough phase to facilitate breakage of the dough, or the aid can be added right before the end of the batch. The aid may alter the surface tension to be water-wet to be compatible with a frac fluid, as described below.

The hydrophobic treatment material, the resin, the adhesion promoter, the resin crosslinker, the aid, or a combination thereof may form a coating on the substrate, and the combination of the substrate with the coating thereon may produce a plurality of coated proppant particles (also referred to as coated proppant pellets). As mentioned above, in one example, the coated proppant particles may be or include CARBOAIR®, where the coating is a curable phenolic novolac coating with residual amine functionality. A residual cure of the coating may be maximized such that it will not interact with the frac fluid components and can be stored in bulk bags in hot/humid environments. In at least one embodiment, the coating may cover less than 100% of an outer surface of the substrate, resulting in areas of exposed substrate. For example, the coating may cover from about 50% to about 99%, about 60% to about 95%, or about70% to about 90% of the outer surface of the substrate.

The coating may be or include a reactive coating, which has the ability to further react under predetermined conditions at a later time. This may be referred to as a partially-cured coating or a B-staged coating. As mentioned above, chemistry that has this capability of yielding a reactive coating for a proppant particle may be or include phenolic novolac, phenolic resole, polyurethane, epoxy, melamine, furan, acrylics, or a combination thereof. A phenolic novolac coating can have an unreacted monomer concentration by weight, or residual reactivity/curability, of any suitable amount. The residual reactivity/curability of a phenolic novolac coating can be from about 0% to about 75% or about 10% to about 50%. In at least one embodiment, the reactive coating may be or include a phenolic novolac coating that has a reactivity/curability from about 20% to about 40%. The number of coating layers and the thickness of the coating may affect the surface curability and resultant properties. The coating may have residual functionality capable of reacting with itself, a chemical activator, or both.

In at least one embodiment, a chemical tracer, such as DNA may be blended or otherwise added to the coating before or during the coating process and/or infused into the substrate. The tracer may be released into fluid passing across the surface of the coating and can subsequently be used to provide qualitative and/or quantitative information about water production or water breakthrough.

Other coatings may be or include a curable epoxy/amine coating with residual epoxy functionality, a curable epoxy/amine coating with residual amine functionality, a curable polyurethane coating with residual isocyanate functionality, and a curable phenolic resole coating.

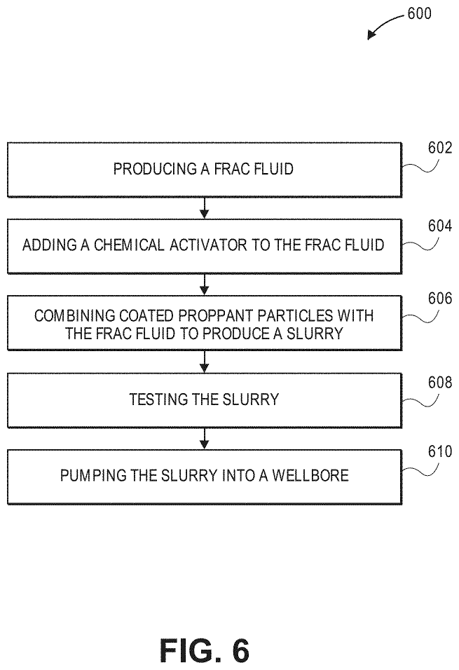

FIG. 6 illustrates a flowchart of a method 600 for producing a slurry for use during or after a hydraulic fracturing operation, according to an embodiment. The method 600 may include producing (or obtaining) a fluid, as at 602. The fluid may be or include a fracturing fluid (also referred to as a frac fluid). Any treatment fluid or fracturing fluid suitable for a hydraulic fracturing operation may be used to carry the proppant. The fracturing fluid may include a non-viscosified water-based fluid, a viscosified water-based fluid, an oil-based fluid, or a foam fluid.

In one or more embodiments, the proppant may be entrained in a viscous fluid for transport during the hydraulic fracturing operation. The fluid may be or include a linear hydrateable gel that includes water, salt, guar, a breaker, a buffer, a friction reducer, a variety of additives such as biocides, clay stabilizers, fluid loss control, surfactants, diverting agents, iron controller, gel stabilizer, or a combination thereof. These ingredients may be combined and/or mixed together in a mixer (i.e., a blender tub). The breakers may be or include a delayed breaker. The breakers may include acids, oxidizers, enzymes or temperature activated breakers. The buffer may be or include sodium bicarbonate or fumaric acid. The friction reducer may be or include an anionic copolymer. The fluid may be from about 5 pounds/gallon to about 45 pounds/gallon or from about 10 pounds/gallon to about 30 pounds/gallon. The linear gel may be further viscosified or crosslinked with a fluid crosslinker. The fluid crosslinker may be an instant or delayed crosslinker. The fluid crosslinker may include borate salts.

In another embodiment, the fluid may be or include a non-viscosified water-based fluid. The fluid may be a slickwater that includes water, salt, a friction reducer, or a combination thereof. These ingredients may be combined and/or mixed together in a mixer.

In yet another embodiment, the fluid may be or include a hydroxyl ethyl cellulose (HEC) fluid including water and hydroxy ethyl cellulose. This fluid may be from about 5 pounds/gallon to about 45 pounds/gallon or from about 10 pounds/gallon to about 30 pounds/gallon.

The method 600 may also include adding a chemical activator (also referred to as a reactive activator) to the frac fluid, as at 604. In at least one embodiment, the chemical activator may be combined with the fluid before the coated proppant particles are combined with the fluid. In another embodiment, the chemical activator may be combined with the fluid after the coated proppant particles are combined with the fluid. In another embodiment, the chemical activator may be combined with the fluid before the fluid is crosslinked or after the fluid is crosslinked. In yet another embodiment, the chemical activator may be combined with the coated proppant particles before the coated proppant particles are combined with the fluid. The chemical activator may make up from about 0.05 wt % to about 1 wt % or from about 0.1 wt % to about 0.6 wt % of the slurry.

The chemical activator may be in liquid form. The composition of the chemical activator may be based on small molecule chemicals, oligomeric chemicals, polymeric chemicals, resin chemicals or a combination thereof. The chemical activator may be or include an epoxy, amine, alcohol, or a combination thereof. For example, the chemical activator may contain epoxy functionality, amine functionality, alcohol functionality, isocyanate functionality, or a combination thereof. More particularly, the chemical activator may be or include a blend of epoxy functional resins. The epoxy functional resins may be based on bisphenol A type, bisphenol F type, or a combination thereof. The chemical activator may include a diluent that serves to reduce viscosity. The diluent may be reactive or non-reactive. For example, the chemical activator may be or include the FUSION activator.

The chemical activator may improve consolidation of the proppant in reservoirs with low temperature and/or low stress (e.g., such as the low stress encountered in a wellbore annulus 1050 described below). The compressive strength of the bonded proppant pack in the fracture is a measure of the ability of the proppant to resist mobilization during normal production from the well, injection into the well, and/or due to formation forces a proppant pack may see downhole. Such forces can be observed in water injection wells where a rapid shut-in can create a water hammer effect such that a pressure surge can be induced by a sudden change in fluid flow velocity. Due to the severity of the water hammer, damage to the formation integrity is commonplace, and sand can be produced with the proppant flowback in wells completed with conventional proppant.

Conventional resin-coated proppants are designed to bond in the fracture and not in the annulus of the wellbore. These conventional resin-coated proppants will not bond sufficiently unless there is a sufficient temperature and stress across the proppant pack. A test to measure the bond strength or the unconfined compressive strength (UCS) of the proppant pack at simulated downhole conditions is called a UCS test. This test may measure proppant pack strength. This may include filling a hollow cylinder (e.g., with a 1 inch diameter) with the proppant slurry to create a slug. The proppant slurry in the cylinder will be subjected to pressure (if any), temperature, and time to consolidate into a proppant pack. Upon removal from the cylinder, the consolidated proppant pack is crushed in a press and the maximum compressive pressure (PSI) recorded. The maximum compressive strength is commonly referred to as pack strength and/or bond strength.

FIG. 8 illustrates an image of a slug 800 created with 0 pounds per square inch (PSI) closure stress, according to an embodiment. In the example shown in FIG. 8, with the chemical activator (for example, FUSION® activator), the proppant slurry in the cylinder will not see any pressure to simulate condition in the wellbore annulus, or the space between a screen and the well bore casing. FIG. 9 illustrates an image of a slug 900 created with 1000 PSI closure stress, according to an embodiment. Both slugs 800, 900 were created using a 24 hour curing time at about 200° F. Curable coatings, like the one described herein, may retain residual reactivity that can be induced upon exposure to certain temperatures and/or pressures to create chemical bonds between the coated proppant particles.

Although a bond strength or UCS of 40 PSI provides sufficient strength to prevent proppant from flowing back in most reservoirs, a higher pack strength (UCS), such as 60 PSI, 80 PSI, 100 PSI, or greater, may be used in preparation for unplanned events. The proppant and/or slurry disclosed herein may consolidate and/or pack (e.g., in a reservoir) at a low temperature and/or a low stress. As used herein, a low temperature may be from about 30° F. to about 160° F. For example, the low temperature may be from about 30° F. to about 80° F., about 80° F. to about 120° F., or about 120° F. to about 160° F. As used herein, a low stress may be from about0 PSI to about 50 PSI. For example, the low stress may be from about 0 PSI to about 10 PSI, about 10 PSI to about 30 PSI, about 30 PSI to about 50 PSI, or about 50 PSI to about 100 PSI. In contrast, conventional chemical activators such as alcohols and/or surfactants, when used with a resin-coated proppant, involve a temperature greater than about 140° F., greater than about 160° F., or greater than about 180° F., and a stress greater than about 50 PSI, greater than about 100 PSI, greater than about 500 PSI, or greater than 1000 PSI to consolidate a proppant in a reservoir. If the coating is an epoxy, urethane, acrylic, or phenolic with residual hydroxyl functionality, then the chemical activator may be or include isocyanate.

In at least one embodiment, if the coating is a phenolic novolac coating, a phenolic resole coating, an epoxy with residual amine coating, or a polyurea with residual amine coating, then the chemical activator may be or include an epoxy. If the coating is an epoxy with a residual expoxide functionality, then the chemical activator may be or include an amine. If the coating is a polyurethane with residual isocyanate functionality or a polyurea with a residual isocyanate functionality, then the chemical activator may be or include one or more of amine or alcohol.

The method 600 may also include combining the coated proppant particles with the fluid to produce a slurry, as at 606. The chemical activator in the fluid may plate on the surface of the coated proppant particles. The chemical activator may also or instead be infused into (e.g., disposed within or throughout) the pore space of the coated proppant particles and migrate to the surface of the coated proppant particles when the coated proppant particles are placed in the fluid. The chemical activator may initiate a chemical reaction with the coated proppant particles. This may activate the coated proppant particles, meaning further curing reaction may take place under the appropriate conditions. In an example, for each gallon of fluid, the amount of coated proppant particles may be from about 0.5 pounds to about 0.12 pounds or from about 2 pounds to about 8 pounds.

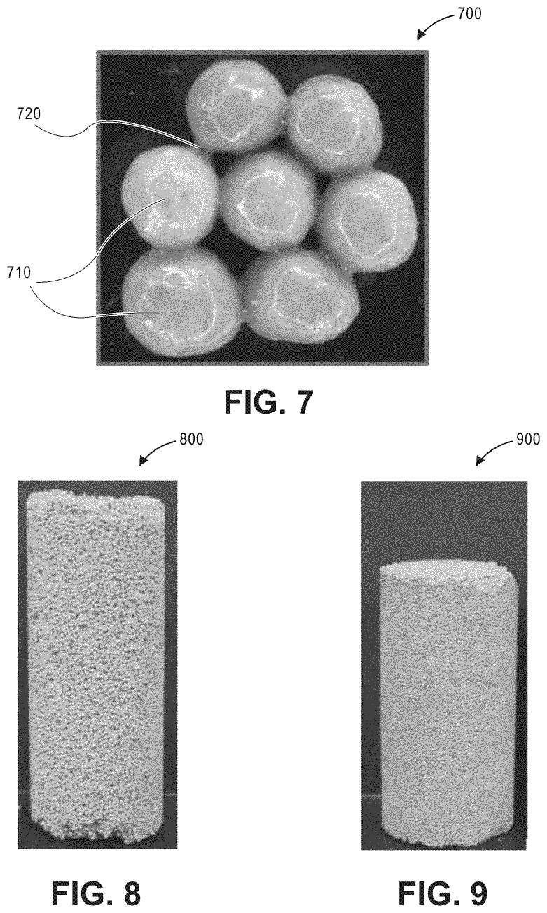

FIG. 7 illustrates an image 700 of a plurality of coated proppant particles 710 with a (e.g., chemical activator in the) fluid 720 bonding the particles 710 together (e.g., through covalent chemical bonds), according to an embodiment. In one embodiment, the chemical activator 720 may be used when the coated proppant particles 710 are to be pumped into a reservoir having a low temperature of at least 40° F. and/or with little to no closure stress (0 PSI).

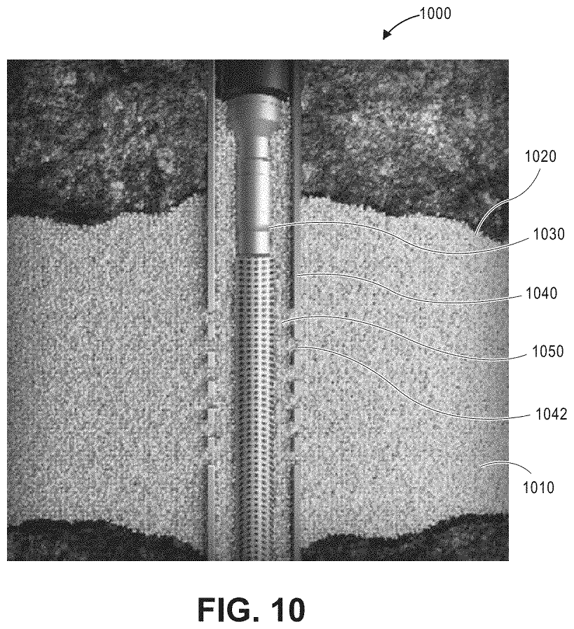

The method 600 may also (optionally) include testing the slurry, as at 608. The method 600 may also include pumping the slurry into a wellbore, as at 610. The slurry may be transported through the wellbore and into one or more fractures formed in a subterranean formation where it may be used to prop open the fracture(s). FIG. 10 illustrates an image 1000 of the slurry 1010 in a fracture 1020, according to an embodiment. As may be seen, the coated proppant particles that are bonded to each other may experience elevated temperatures and/or closure stress in the fracture 1020, similar to that shown in FIG. 9, which may cause the slurry 1010 to form a consolidated proppant pack in the fracture 1020. In at least one embodiment, at least a portion of the slurry 1010 may fill up an annulus 1050 formed between an inner tubular 1030 and an outer tubular 1040. The inner tubular 1030 may be or include a screen, and the outer tubular 1040 may be or include a casing, which may include one or more perforations 1042 to provide a path of fluid communication between the fracture 1020 and the annulus 1050. The annulus 1050 may have a lesser stress than the fracture 1020. For example, the pressure in the annulus 1050 may be 50 PSI or less (e.g., as low as 0 PSI). However, the chemically activated resin coated proppant may still allow the proppant particles to consolidate under this lower closure stress.

The coated proppant particles combine the benefits of proppant transport with the ability to produce a strong proppant pack under a variety of conditions, thereby maximizing oil and/or gas production and efficiency or water injection well performance. The lightweight nature of the coated proppant particles disclosed herein results in a lower settling rate, thereby allowing the coated proppant particles to have enhanced transport characteristics. Several oilfield applications that utilize curable resin-coated proppant technology can benefit from the enhanced transport properties. For example, the proppant and activator system disclosed herein may be pumped into a horizontal multi-stage fractured well, and highly conductive fractures with increased frac length and height, combined with proppant pack consolidation near the wellbore, may prevent proppant flowback. In another example, high quality cased hole or open hole gravel packs in vertical, deviated, or horizontal wells can be efficiently created using low completion fluid viscosity and low pump rates. Other examples of oilfield applications that may benefit from the coated proppant particles disclosed herein may include vertical frac and packs, and horizontal frac and packs, where the lightweight nature of the proppant may minimize the risk of premature screenout and increase frac length and height. The coated proppant particles may consolidate in reservoirs where temperature is low and/or closure stress is low by adding the chemical/reactive activator. In addition, when a NRT material is added into the coated proppant particles, a user may directly measure proppant placement in the annulus of the wellbore as well as the fracture height across the perforations. Moreover, a DNA tracer may be added into the coated proppant particles to track water breakthrough in water injection wells. The DNA tracer may also be detected in produced water and/or oil from each stage.

As used herein, the terms “inner” and “outer”; “up” and “down”; “upper” and “lower”; “upward” and “downward”; “above” and “below”; “inward” and “outward”; “uphole” and “downhole”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. Gravel pack particles, comprising:
a plurality of a porous ceramic substrate;
a hydrophobic treatment material disposed on the porous ceramic substrates;
an adhesion promoter disposed on the porous ceramic substrates;
a resin disposed on the hydrophobic treatment material and the adhesion promoter;
a resin crosslinker in contact with the resin; and
a surface treatment material disposed on the resin.

2. The gravel pack particles of claim 1, wherein the resin comprises a novolac resin, phenolic resole resin, epoxy resin, urea resin, acrylic resin and/or combination thereof.

3. The gravel pack particles of claim 1, wherein the substrate has an interconnected internal porosity from about 1% to about 75%.

4. The gravel pack particles of claim 1, wherein the hydrophobic treatment material is disposed on an outer surface and interior channel walls of the substrate.

5. The gravel pack particles of claim 1, wherein the hydrophobic treatment material is selected from the group consisting of silicones, silanes, siloxanes, fluorinated organic compounds, linseed oil, soybean oil, corn oil, cottonseed oil, vegetable oil, canola oil, hydrocarbons, and paraffin, and any combination thereof.

6. The gravel pack particles of claim 2, wherein the resin comprises a novolac resin having a molecular weight from about 400 to about 5000 and a melt viscosity at 150° C. from about 1000 to about 35000 cPs.

7. The gravel pack particles of claim 1, wherein the adhesion promoter comprises an amine functional silane that forms a covalent bond between the substrate and the resin.

8. The gravel pack particles of claim 1, wherein the resin crosslinker comprises hexamethylenetetramine, and wherein a ratio of the hexamethylenetetramine to the resin is from about 5:100 to about 25:100.

9. The gravel pack particles of claim 1, wherein the surface treatment material comprises a parting aid, a wetting aid, or both that alters a surface tension of the coated proppant particle to be substantially water-wet such that the coated proppant particle is compatible with a frac fluid.

10. The gravel pack particles of claim 1, wherein the hydrophobic treatment material, the resin, the adhesion promoter, the resin crosslinker, the surface treatment material, or a combination thereof form a coating on the substrate, and wherein the coating covers less than 100% of an outer surface of the substrate, resulting in areas of exposed substrate.

11. The gravel pack particles of claim 10, wherein the coating has residual functionality capable of reacting with itself, a chemical activator, or both.

12. The gravel pack particles of claim 1, wherein the resin crosslinker comprises amine, epoxy, alcohol, or isocyanate functionality or any combination thereof.

13. A proppant slurry, comprising:
the gravel pack particles of claim 1;
a frac fluid; and
a chemical activator.

14. The proppant slurry of claim 13, wherein the chemical activator comprises epoxy, amine, alcohol, or isocyanate or a combination thereof.

15. The proppant slurry of 13, wherein the chemical activator is configured to promote the coated proppant particles to consolidate at a temperature that is less than or equal to about 160° F.

16. The proppant slurry of claim 13, wherein the chemical activator is configured to promote the coated proppant particles to consolidate at a stress that is less than or equal to about 50 pounds per square inch (PSI).

17. The proppant slurry of claim 13, wherein the coated proppant particles are configured to produce a proppant pack having a unconfined compressive strength of at least 50 pounds per square inch (PSI), even when the coated proppant particles are not exposed to temperatures in excess of about 160° F.

18. A method, comprising:
heating a porous ceramic substrate;
adding a hydrophobic treatment material to the substrate;
adding a resin to the substrate;
adding an adhesion promoter to the substrate;
adding a resin crosslinker to the substrate; and
adding a surface treatment material to the substrate, wherein the hydrophobic treatment material, the resin, the adhesion promoter, the resin crosslinker, the surface treatment material, or a combination thereof form a coating on the substrate, and the substrate and the coating produce a plurality of coated proppant particles.

19. The method of claim 18, wherein the coating comprises an amine-cured phenolic novolac coating.

20. The method of claim 19, further comprising combining the coated proppant particles with a frac fluid to produce a slurry.

21. The method of claim 20, further comprising adding a chemical activator to the frac fluid, to the slurry, or both, wherein the chemical activator comprises epoxy, amine, alcohol, or a combination thereof.

22. The method of claim 21, wherein the chemical activator is configured to promote the slurry to consolidate at a temperature that is less than or equal to about 160° F. and at a stress that is less than or equal to about 50 pounds per square inch (PSI).

23. The method of claim 22, further comprising pumping the slurry into an annular region of a wellbore, a fracture, or both.
